(19) United States
(12) Patent Application Publication
(10) Pub. No.: US 2024/0345883 A1
(43) Pub. Date: Oct. 17, 2024

(54) MACHINE LEARNING ACCELERATOR PAIRED WITH GENERAL PURPOSE RECONFIGURABLE COMPUTING CORE

(71) Applicant: QUALCOMM Incorporated, San Diego, CA (US)

(72) Inventors: Ioannis NOUSIAS, San Diego, CA (US); Vishal Ganesh SHITOLE, Irvine, CA (US); Deeksha DIXIT, San Diego, CA (US); Sami KHAWAM, San Diego, CA (US); Ben VANDERGRIEND, Sequim, WA (US); Mark Ian Roy MUIR, San Diego, CA (US)

(21) Appl. No.: 18/681,825

(22) PCT Filed: Sep. 22, 2022
(86) PCT No.: PCT/US2022/044448

§ 371 Date: Feb. 6, 2024

(30) Foreign Application Priority Data
Oct. 4, 2021 (GR) 20210100674

(51) Int. Cl. G06F 9/50

(52) U.S. Cl. CPC G06F 9/5027; G06F 9/5061

(57) ABSTRACT

A method for accelerating machine learning on a computing device is described. The method includes partitioning neural network parameters and input data processed by a plurality of multiply-accumulate (MAC) units of a MAC array of the computing device. The method also includes interleaving MAC operations on the neural network parameters and the input data accessed according to a data sliding window and/or a stride N to compute an output during each cycle, in which N is greater than or equal to one.

### TECHNICAL FIELD

Certain aspects of the present disclosure generally relate to artificial neural networks and, more particularly, to a machine learning (ML) accelerator paired with a general purpose reconfigurable computing core.

### BACKGROUND

An artificial neural network, which may include an interconnected group of artificial neurons, may be a computational device or may represent a method to be performed by a computational device. Artificial neural networks may have corresponding structure and/or function in biological neural networks. Artificial neural networks, however, may provide useful computational techniques for certain applications, in which traditional computational techniques may be cumbersome, impractical, or inadequate. Because artificial neural networks may infer a function from observations, such networks may be useful in applications where the complexity of the task and/or data makes the design of the function burdensome using conventional techniques.

In computing, hardware acceleration is the use of computer hardware to perform some functions more efficiently than is possible in software running on a more general purpose central processing unit (CPU). The hardware that performs the acceleration may be referred to as a hardware accelerator. Machine learning accelerators may improve the performance of artificial neural networks. Unfortunately, data traffic in machine learning hardware accelerators is problematic because machine learning hardware accelerators are bandwidth limited. Techniques for reducing data traffic within bandwidth limited machine learning accelerators paired with a general purpose reconfigurable computing core are desired.

### SUMMARY

A method for accelerating machine learning on a computing device is described. The method includes partitioning neural network parameters and input data processed by a plurality of multiply-accumulate (MAC) units of a MAC array of the computing device. The method also includes interleaving MAC operations on the neural network parameters and the input data accessed according to a data sliding window and/or a stride N to compute an output during each cycle, in which N is greater than or equal to one.

A method for accelerating machine learning on a computing device is described. The method includes partitioning neural network parameters and an input data processed by a plurality of multiply-accumulate (MAC) units of a MAC array of the computing device. The method also includes loading a data slice of the input data according to a data slice format. The method further includes fetching a set of current coefficient slices using a first memory page. The method also includes prefetching a set of next coefficient slices using a second memory page. The method further includes performing a convolution operation between the current set of coefficients slices and a portion of the data slice according to a data sliding window.

A system for a machine learning (ML) acceleration architecture is described. The system includes a machine learning (ML) accelerator. The system also includes a reconfigurable system on chip (SoC) coupled top the ML accelerator. The reconfigurable SoC is configured to partition neural network parameters and input data processed by ML accelerator. In addition, the ML accelerator is configured to interleave operations on the neural network parameters and the input data accessed according to a data sliding window and/or a stride N to compute an output during each cycle, in which N is greater than or equal to one.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims.

The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-chip (SoC), including a general purpose processor, in accordance with certain aspects of the present disclosure.

FIGS. 2A, 2B, and 2C are diagrams illustrating a neural network, in accordance with aspects of the present disclosure.

FIG. 2D is a diagram illustrating a neural network, in accordance with aspects of the present disclosure.

FIG. 3 is a block diagram illustrating a machine learning (ML) acceleration architecture having a general purpose reconfigurable computing core, in accordance with aspects of the present disclosure.

FIG. 4 is a block diagram illustrating control flow and data flow in a machine learning (ML) acceleration architecture, in accordance with aspects of the present disclosure.

FIGS. 5A and 5B are block diagrams illustrating control flow and data flow in a machine learning (ML) acceleration architecture, in accordance with aspects of the present disclosure.

FIGS. 6A-6D illustrate various memory and/or data partitions as well as an adder tree, according to aspects of the present disclosure.

FIGS. 7A-7C are block diagrams illustrating a simplified configuration of the machine learning (ML) acceleration architecture to provide virtual data rotation to support memory partitioning, in accordance with aspects of the present disclosure.

FIG. 8 is a block diagram illustrating interleaved data striding in a machine learning (ML) acceleration architecture, in accordance with aspects of the present disclosure.

FIG. 9 is a block diagram illustrating a chaining of sliding data windows between multiply-accumulate (MAC) units of a MAC array, in accordance with aspects of the present disclosure.

FIG. 10 further illustrates the multiply-accumulate (MAC) units of a MAC array according to a chaining configuration or parallel coefficient loading, in accordance with aspects of the present disclosure.

FIG. 11 is a block diagram further illustrating dedicated local accumulators to enable support for partial sums into intermediate buffers, according to aspects of the present disclosure.

FIG. 12 is a block diagrams illustrating a memory/data partition technique to perform various convolutions, in accordance with aspects of the present disclosure.

FIG. 13 is a flow diagram illustrating a method for accelerating of machine learning on a computing device, in accordance with aspects of the present disclosure.

FIG. 14 is a flow diagram illustrating a method for accelerating of machine learning on a computing device, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. Nevertheless, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

Although particular aspects are described, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure, rather than limiting the scope of the disclosure being defined by the appended claims and equivalents thereof.

In computing, hardware acceleration is the use of computer hardware to perform some functions more efficiently than is possible in software running on a more general purpose central processing unit (CPU). The hardware that performs the acceleration may be referred to as a hardware accelerator. Machine learning accelerators may improve the performance of artificial neural networks. Unfortunately, data traffic in machine learning hardware accelerators is problematic because machine learning hardware accelerators are bandwidth limited. Techniques for reducing data traffic within bandwidth limited machine learning accelerators paired with a general purpose reconfigurable computing core are desired.

In particular, data traffic in machine learning (ML) accelerators is especially problematic. Often, ML accelerators are bandwidth limited rather than computationally limited. An ML accelerator for a convolutional neural network (CNN) may provide the benefit of data streaming techniques to prevent the CNN from becoming a data bottleneck. Furthermore, fast coefficient reloading and memory partitioning are possible solutions provided by ML accelerators for reducing traffic. For example, image restoration networks exhibit a low parameter count, but suffer from a high pixel count. As a result, image restoration networks can afford serialized coefficient loading when prefetching is used; however, these image restoration networks specify higher bandwidth for pixel data. By contrast, regression/classification/dimensionality reduction networks exhibit a high parameter count, but a low pixel count. As a result, for these networks, coefficient loading is a likely source of a data bottleneck.

Some aspects of the present disclosure are directed to a data bandwidth reduction in ML accelerators paired with a general purpose reconfigurable computing core. In some aspects of the present disclosure, the ML accelerator is a multiply-accumulate (MAC) array configured to process input data and neural network coefficients using a sliding data window by cascading data and virtual bank rotation using a cross-bar. In these aspects of the present disclosure, the ML accelerator is provided by a MAC array that is tightly integrated with a memory architecture, and configured with interleaved striding and dilated convolutions as well as local partial sums. Is some aspects of the present disclosure, MAC units of the MAC array are paired with memory interfaces, in which each memory interface may be paired with any memory bank. This configuration enables efficient coefficient reload and/or memory partitioning. In addition, this configuration also enables parallel access to local stream-buffers for fast loading. In addition, the MAC array supports chaining from a streaming buffer, for more compact partitioning and data reuse, according to aspects of the present disclosure. As described, chaining may refer to a data reuse technique in which a partition of data is reused to perform, for example, neural network operations such as convolution using network weights or digital processing techniques, such as down sampling.

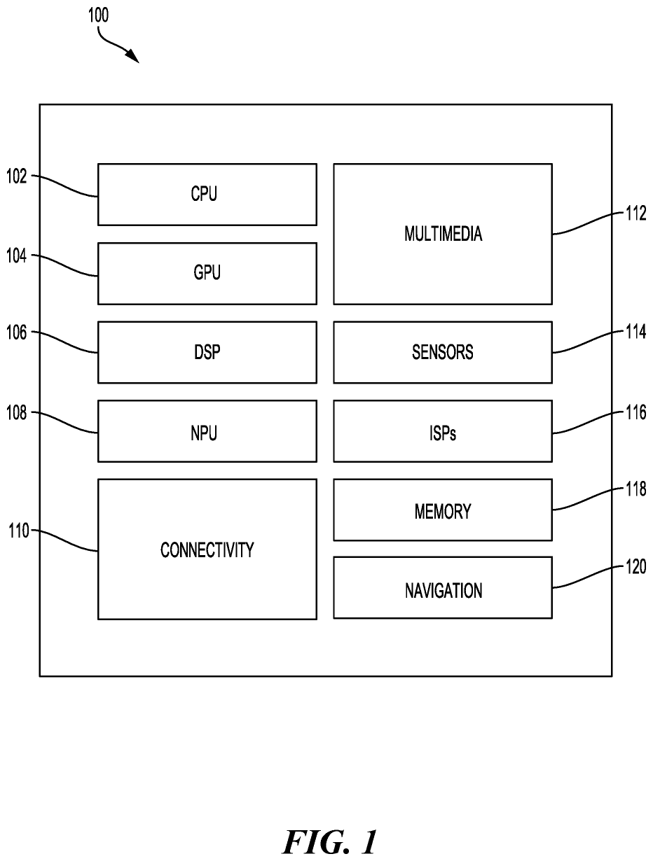

FIG. 1 illustrates an example implementation of a system-on-chip (SoC) 100, which may include a central processing unit (CPU) 102 or multi-core CPUs, in accordance with certain aspects of the present disclosure, such an artificial intelligence (AI) accelerator. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SoC 100 may also include additional processing blocks tailored to specific functions, such as a connectivity block 110, which may include fifth generation (5G) new radio (NR) connectivity, fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SoC 100 may also include a sensor processor 114 to provide sensor image data, image signal processors (ISPs) 116, and/or navigation module 120, which may include a global positioning system.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

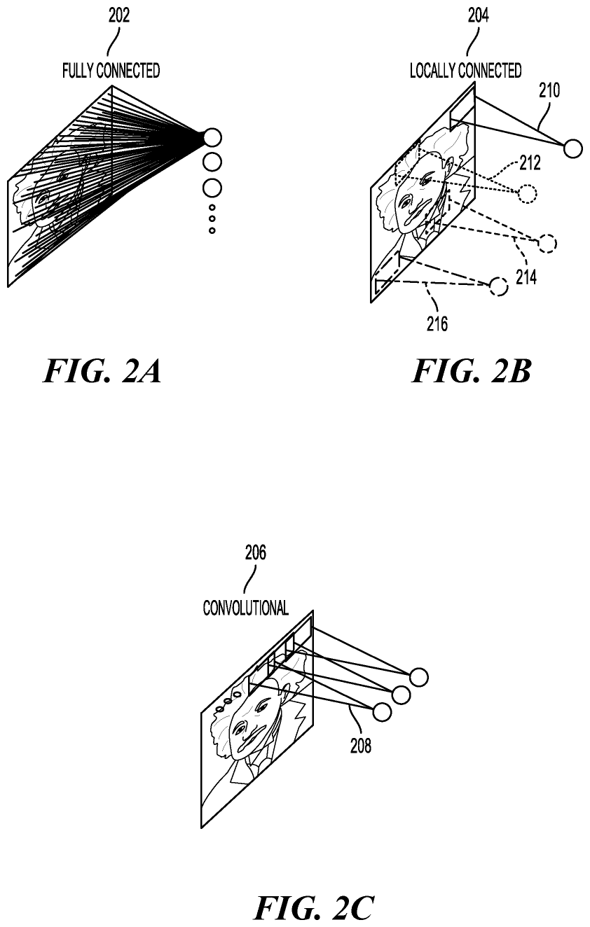

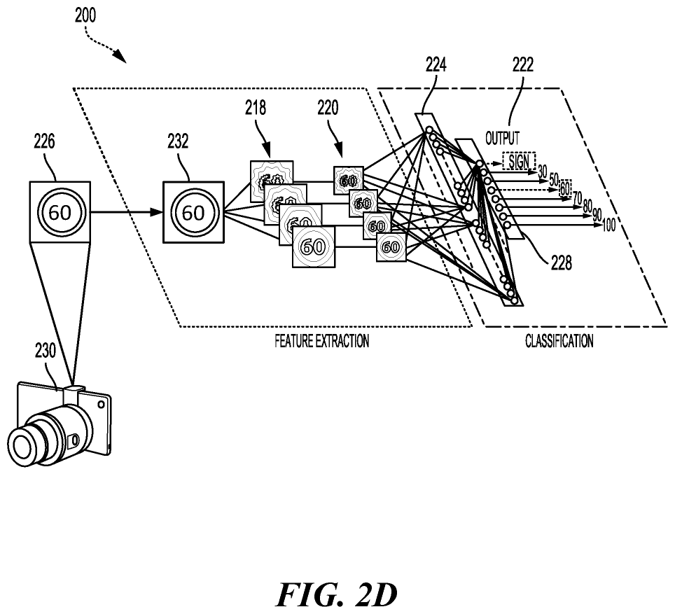

The connections between layers of a neural network may be fully connected, skip connected, or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. Connections between layers of the neural network using skip connections may be provided for residual networks. Skip connections were first introduced in residual networks (ResNet) and are common building blocks in modern CNNs, such as U-Nets etc.

As described, skip connections are network output features that come from an earlier layer in the CNN flow, and are fed to a deeper layer, skipping layers in between. At the point where the skip connections are fed, the skip connections are typically added to the network output features of that layer. The layers between the point the skip connection branches off and the layer it merges back, are said to learn residuals. That is, rather than learning a transformation of their input to the desired output, the layers between the point the skip connection branches off and the layer it merges back learn deltas/differences/residuals between their inputs and the desired output.

FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connection strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different convolutional kernels were applied to the image 226 at the convolutional layer 232, four different feature maps are generated in the first set of feature maps 218. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100.” Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

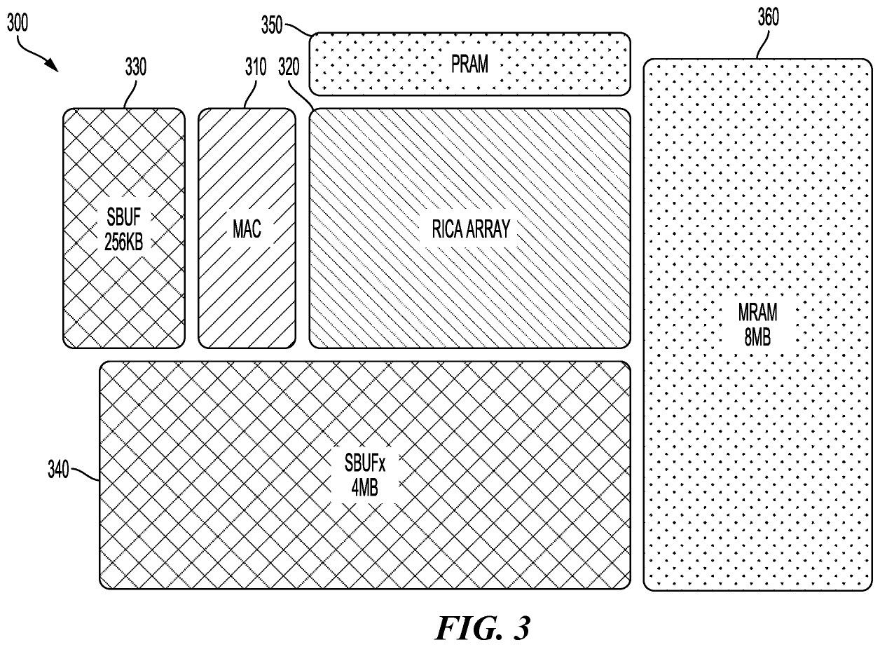

FIG. 3 is a block diagram illustrating a machine learning (ML) acceleration architecture 300 having a general purpose reconfigurable computing core, in accordance with aspects of the present disclosure. The ML acceleration architecture 300 includes an AI accelerator (e.g., a multiply-accumulate (MAC) array 310) and a general purpose reconfigurable computing core (e.g., a reconfigurable instruction cell array (RICA)). In this configuration, the ML acceleration architecture 300 includes a program random access memory (PRAM) 350, and a magnetic random access memory (MRAM) 360. In addition, the ML acceleration architecture 300 includes two data memory domains provided by a first memory buffer 330 (SBUF) and a second memory buffer 340 (SBUFx).

As shown in FIG. 3, the RICA array 320 is implemented as a reconfigurable system-on-chip (SoC), including a set of instruction cells that may be reconfigured or sequenced as desired. Once configured and loaded, an instruction can persist for multiple iterations as different batches of data are introduced to the configured combination of instruction cells in a controlled path. The RICA array 320 (e.g., reconfigurable SoC) provides the flexibility of mapping the processing paths for both independent and dependent instructions. In addition, the RICA array 320 may be programmed using a conventional software programming language (e.g., C/C++) to define a set of configuration contexts, each representing a set of data paths configured on the array of instruction cells. The program executes by switching between different configuration contexts of the RICA array 320.

The RICA array 320 provides an architecture developed as an efficient compromise between instruction-based architectures and dedicated hardware approaches. The RICA array 320 may be implemented with a switching fabric that may be reprogrammed each clock cycle to implement a given algorithm or function. The RICA array 320 enables support for algorithms such as image processing that involves processing multiple pixels through a pipelined processing scheme can be mapped to instruction cells in a manner that emulates a dedicated hardware approach. In particular, the RICA array 320 avoids the design of dedicated hardware by instead programing the cells and switching fabric of the RICA array 320 to implement the image processing algorithm

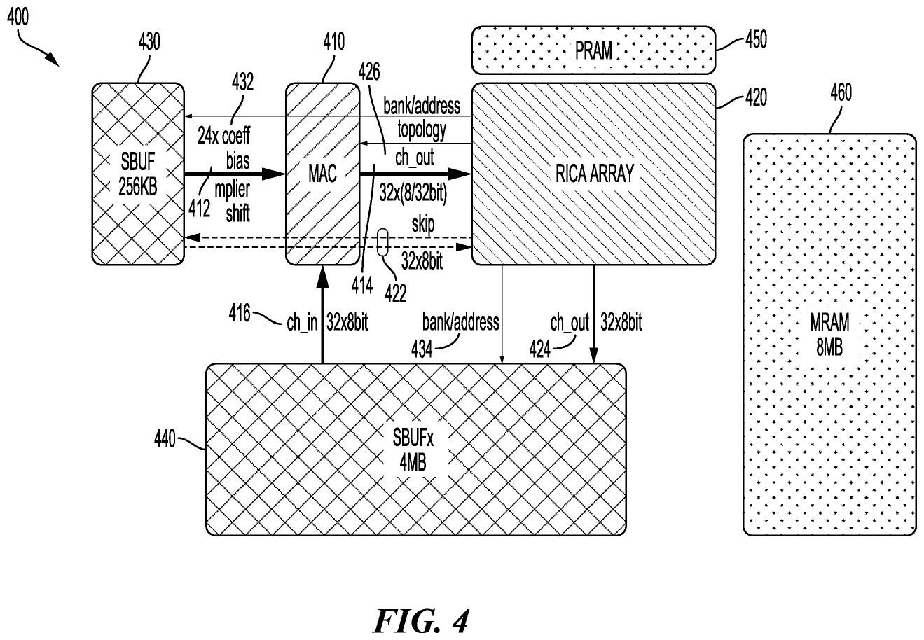

Unfortunately, data traffic in the MAC array 310 is especially problematic. In this configuration, the MAC array 310 is bandwidth limited rather than computationally limited due to a data bottleneck. Fast coefficient reloading and memory partitioning are possible solutions provided by the MAC array 310 for reducing data traffic with the ML acceleration architecture 300. Nevertheless, different neural networks operate according to different data specification. For example, image restoration networks exhibit a low parameter count, but suffer from a high pixel count. As a result, image restoration networks specify higher bandwidth for pixel data. By contrast, for regression/classification/dimensionality reduction networks, coefficient loading is a likely source of a data bottleneck. In some aspects of the present disclosure, the MAC array 310 is configured to process input data and neural network coefficients using interleaved striding combined with a sliding window, as further illustrated in FIG. 4.

FIG. 4 is a block diagram illustrating control flow and data flow in a machine learning (ML) acceleration architecture 400, in accordance with aspects of the present disclosure. In this configuration, the ML acceleration architecture 400 may be similar to the ML acceleration architecture 300 shown in FIG. 3. In these aspects of the present disclosure, the ML accelerator is provided by a multiply-accumulate (MAC) array 410 that is tightly integrated with a memory architecture, and configured with interleaved striding and dilated convolutions as well as local partial sums. Is some aspects of the present disclosure, MAC units of the MAC array 410 are paired with memory interfaces, in which each memory interface may be paired with any memory bank. This configuration enables efficient coefficient reload and/or memory partitioning. This configuration also enables parallel access to local stream-buffers for fast loading. In addition, the MAC array 410 supports chaining from a streaming buffer, for more compact partitioning, according to aspects of the present disclosure.

In some aspects of the present disclosure, the ML acceleration architecture 400 provides two data memory domains for a reconfigurable instruction cell array (RICA) array 420: a first storage buffer 430 (e.g., SBUF with 256 KB of storage and 32 memory banks) and a second storage buffer 440 (e.g., SBUFx with 4 MB of storage and 32 memory banks). The RICA array 420 also includes 64 data interfaces, including 64 simultaneous 16-bit read and write interfaces as well as 64 32-bit read or write interfaces. In addition, a program cache of the RICA array 420 is provided by a PRAM 450, in which a size (e.g., 300 KB PRAM) is sufficient to hold a resident program. In addition, the program cache PRAM 450 may be updated in the background based on control flow. The ML acceleration architecture 400 also includes an embedded non-volatile random access memory (RAM) 460, such as a magnetic random access memory (MRAM), with 8 MB of storage. In this configuration, the non-volatile MRAM 460 provides non-volatile storage for program and neural network (NN) coefficients.

In some aspects of the present disclosure, the MAC array 410 is configured with parallel access to a first channel input data 412 and a second channel input data 416 (e.g., ch_in). In this example, the first channel input data 412 provides access to network parameters (e.g., coefficients, weights, fixed-point multiplier and shift adjustments, and activation function) stored in the first storage buffer 430. In addition, the RICA array 420 is configured with access to bank associations (e.g., bank/address 432) from which the MAC array 410 reads (as well as bank/address 434). The RICA array 420 is further configured with access to network channel outputs 414 and 424 (ch_out) for writing network topology information 426 as well as a write-back of a channel output from current layer to a channel input of a next layer.

The RICA array 420 may include sets of four-eight-bit over eight interfaces, when network output features are supported, as well as a set of 32 8 bit over 32 (e.g., 32×(8/32 bit)) interfaces for custom normalizations or activation functions. These interfaces are collectively shown with referred as RICA interfaces 422, which may be used to communicate skip. In addition, the RICA array 420 is configured to directly load the second storage buffer 440 with network output features for a next layer, which optionally using the first storage buffer 430 for skip neural network connections. In this aspect of the present disclosure, coefficients are provided from the first storage buffer 430 and data is provided from the second storage buffer 440. This configuration of the ML acceleration architecture 400 utilizes all 32 interfaces to access all 32 MAC outputs at their internal 32-bit precision. In addition, this configuration of the ML acceleration architecture 400 enables the RICA array 420 to perform some or all the output stages, such as scaling, normalization, activation function, and other like output stages.

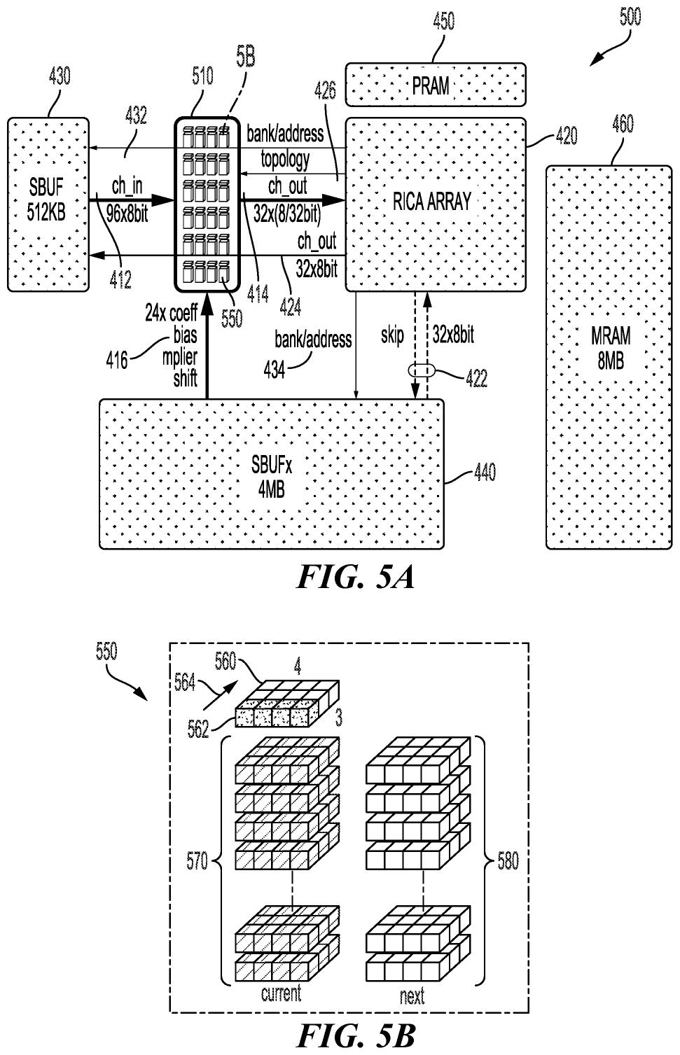

FIGS. 5A and 5B are block diagrams illustrating control flow and data flow in a machine learning (ML) acceleration architecture, in accordance with aspects of the present disclosure. In this configuration, an ML acceleration architecture 500 may be similar to the ML acceleration architecture 400 shown in FIG. 4, including similar reference numbers. In this aspect of the present disclosure, coefficients are provided from the second storage buffer 440 and data is provided from the first storage buffer 430.

As shown in FIG. 5A, a MAC array 510 is configured with 24 MAC units, according to aspects of the present disclosure. A MAC unit 550 is shown in an exploded view in FIG. 5B, according to aspects of the present disclosure. In this example, the MAC unit 550 includes a data slice 560 (e.g., with dimensions of 1 row×3 columns×4 input channels (i.e., 1×3×4) according to a data slice format) configured to stream a set of four channels according to a data sliding window that partitions memory into execution units. According to aspects of the present disclosure, the data sliding window enabled by the data slice 560 of the MAC unit 550 reduces data bandwidth and, in this configuration, provides a horizontal history in shift registers of the ML acceleration architecture 500.

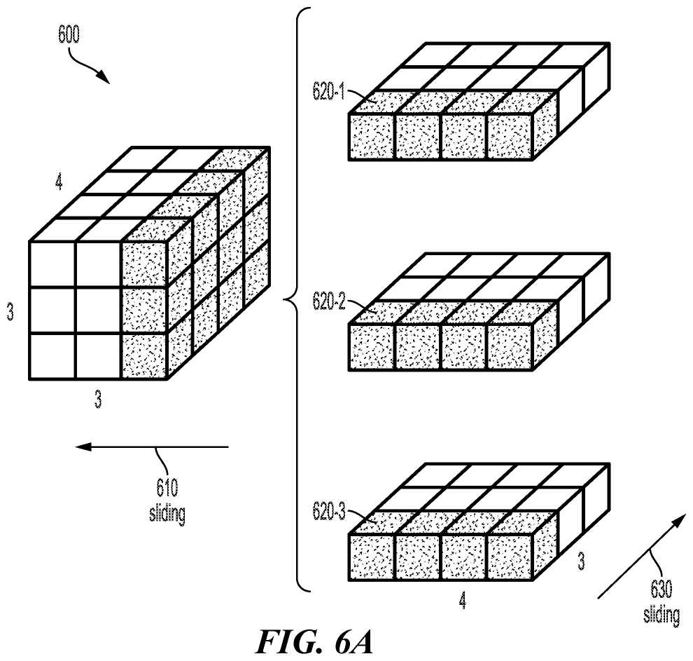

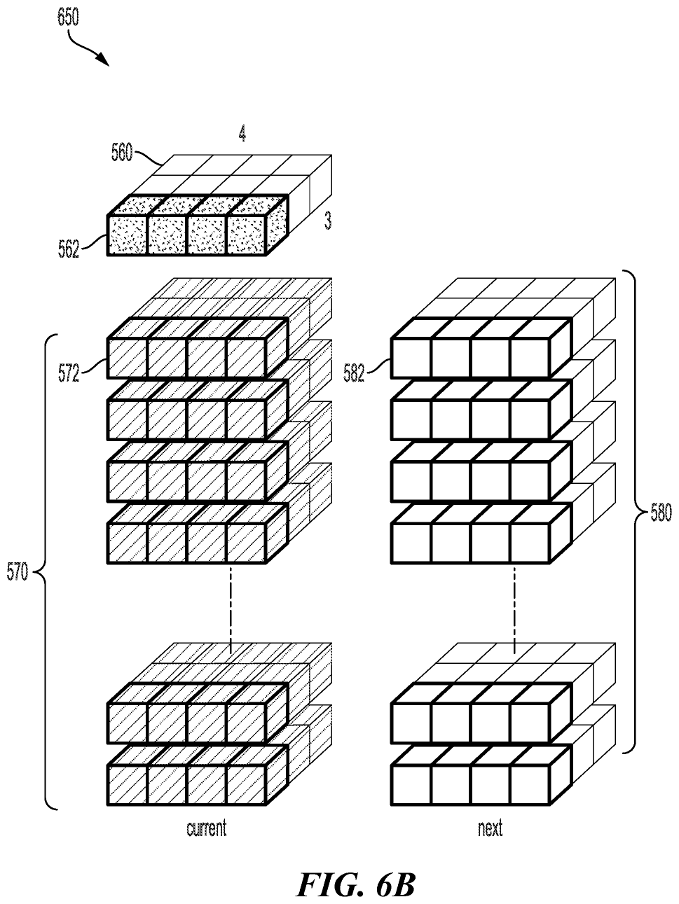

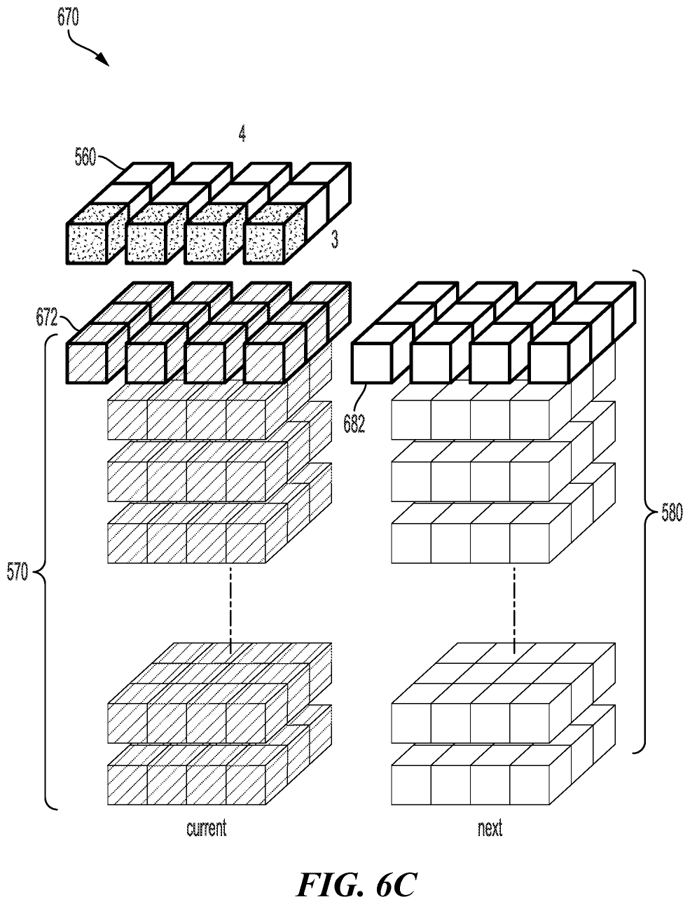

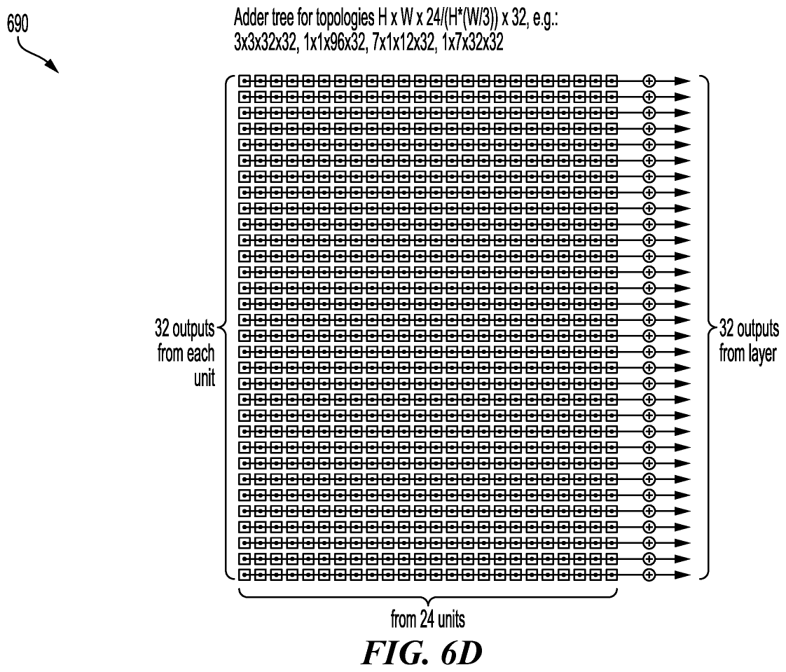

In this example, rather than fetching the full 12 bytes of data of the data slice 560, aspects of the present disclosure may reduce bandwidth by limiting the fetching of data to four bytes of data per cycle. In this example, a first data column 562 of the data slice 560 is repeated for calculation with current coefficient slices 570 during a cycle to perform a convolution operation. According to a sliding window 564 beginning with the first data column 562 of the data slice 560, a new data column of four input channels is used for each cycle to perform the convolution operation. This data reuse technique may be referred to as streaming of data of the data slice 560. The sliding window 564 is further illustrated in FIG. 6A

As further illustrated in FIG. 5B, the MAC unit 550 includes 32 current coefficient slices 570 (e.g., with 1×3×4 dimensions according to a coefficient slice format) in a similar configuration to the data slice 560. In this configuration, each of the MAC units of the MAC array 510 is paired with an interface of the second storage buffer 440 (e.g., SBUFx interfaces). In addition, each of the SBUFx interfaces may be paired with any bank of the corresponding memory domains of the ML acceleration architecture 500. In some aspects of the present disclosure, the MAC unit 550 is configured to perform 32 products between the data slice 560 and the current coefficient slices 570. In this example, two memory pages (e.g., a first memory page and a second memory page) provided by the MAC unit 550 allow fetching a set of current coefficient slices 570 and prefetching a set of next coefficient slices 580. The prefetching of the set of next coefficient slices 580 hides away loading during execution of a current line of coefficients.

In this configuration, a four-byte interface of the MAC array 510 specifies 96 cycles (e.g., =32×3) to completely load. The configuration of the MAC unit 550 shown in FIG. 5B, including the data slice 560 and the set of current coefficient slices 570, enables various sorts of matrix/dot-product type of operations. For example, the matrix/dot-product type of operations may include regular filters, discrete Fourier transforms (DFT), discrete cosign transforms (DCT), wavelets, and normalized cross correlation (NCC). In addition, the data configuration of the MAC unit 550 enables fast reloading of coefficients and enables more dynamic use-cases, such as a block matching 3D filter (BM3D) and attention mechanisms (e.g., transformers).

FIGS. 6A-6D illustrate various memory and/or data partitions as well as an adder tree, according to aspects of the present disclosure. FIG. 6A is a block diagram illustrating MAC unit cube formation, in accordance with aspects of the present disclosure. In this configuration, a convolution cube 600 is formed by combining the data slices 620-1, 620-2, and 620-3. In this example, a sliding window 610 of the convolution cube 600 and a sliding window 630 of the data slices 620 are shown. In some aspects of the present disclosure, combining multiple lines of history from the data slices 620 is used to form the convolution cube 600. This example forms a data cube (e.g., 3×3×4 data) and a corresponding convolution cube (e.g., 3×3×4×32 coefficients). In addition, further combining of stacks together may be performed to form deeper cubes (e.g., 3×3×4×8=3×3×32 data, 3×3×32×32 coefficients).

FIG. 6B further illustrates the MAC unit 550 of FIG. 5B according to a reduced memory partition 650 to enable 1×1 convolutions, according to aspects of the present disclosure. In this configuration, one-third of the data slice 560, such as the first data column 562 of four input channels is used to perform a 1×1 convolution. In addition, one-third of the current coefficient slices 570, such as a first convolution slice column 572, and one-third of the next coefficient slices 580, such as a first convolution slice row 582, are utilized to perform the 1×1 convolution with the first data column 562. This reduced memory partition 650 provides faster loading times: In particular, because a coefficient loading chain is performed column first, 32 cycles are specified to perform the coefficient loading, including auto-reset support. This reduced memory partition 650 is beneficial for bandwidth limited applications.

FIG. 6C further illustrates the MAC unit 550 according to a memory partition 670 to enable depth-wise convolution, according to aspects of the present disclosure. The memory partition 670 provides a special mode, in which channels are convolved independently. In this example, a single coefficient slice is used. For example, a first convolution slice 672 of the current coefficient slices 570 and a first convolution slice 682 of the next coefficient slices 580 are used to perform the depth-wise convolution operation. In this example, the memory partition 670 provides four output channels per MAC unit of 1×3 convolutions.

As shown in FIG. 6C, multiple MAC units may be combined to provide an increased height (e.g., 3×3 uses three MAC units). In some aspects of the present disclosure, the memory partition 670 enables a special mode for adder trees, such as an adder tree 690 as shown in FIG. 6D, in which channels are treated independently. In this configuration, using 24 units of the first storage buffer 430 provides 3×3×32 depth-wise convolutions. In addition, the memory partition 670 of FIG. 6C enables loading of coefficients for depth-wise convolutions within three cycles.

As shown in FIG. 6D, the adder tree 690 enables combining together multiple 3×3×4 convolutions to form deeper convolutions. This configuration of the adder tree 690 beneficially allows more flexible configurations to support multiple network geometries. In addition, bias, normalization, and q-correction terms may be loaded at an end of the adder tree 690.

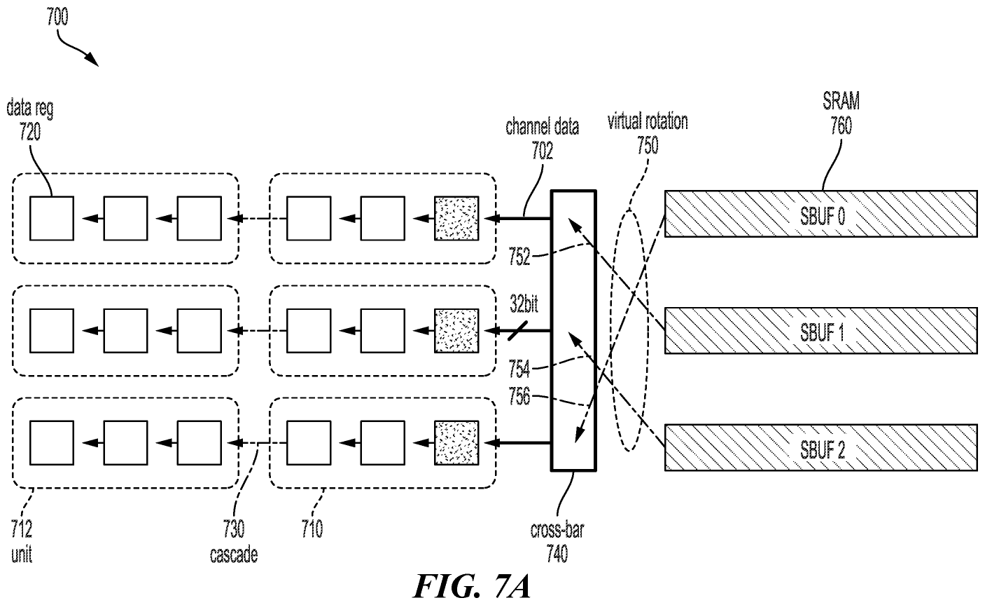

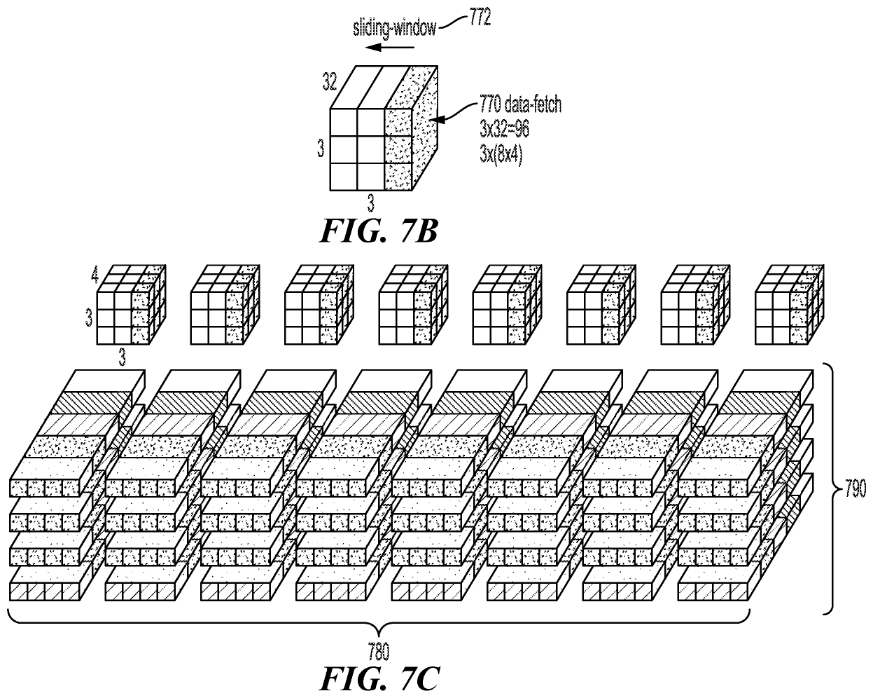

FIGS. 7A-7C are block diagrams illustrating a simplified configuration of the machine learning (ML) acceleration architecture 700 to provide virtual data rotation to support memory partitioning, in accordance with aspects of the present disclosure. In the ML acceleration architecture 700, a first stage of units 710 and a second stage of units 712, each include data registers 720. In this configuration, the first stage of units 710 and the second stage of units 712 are coupled together using a cascade 730 to provide a serial connection. A cross-bar 740 is coupled between the first stage of units 710 and storage buffers 760 (e.g., SBUF 0, SBUF 1, SBUF 2) to provide channel data 702. In this configuration, the storage buffers 760 undergo a virtual rotation 750 beginning with SBUF 0 and continuing to SBUF 2, which are either moved upward or downward by the cross-bar 740 according to arrows 752, 754, and 756. In some aspects of the present disclosure, the ML acceleration architecture 700 supports a read and then overwrite scheme of the channel data 702 in the storage buffers 760.

FIGS. 7B and 7C illustrate a memory partitioning configuration for a 3×3×32×32 convolution, according to aspects of the present disclosure. As shown in FIG. 7B, a data-fetch 770 enables data streaming according to a sliding window 772, which has a dimension of 3×32 (96=3×(8×4). This data-fetch 770 enables 32 input channels represented as eight memory banks 780 and 32 output channels, as shown in FIG. 7C. In addition, the data-fetch 770 corresponds to four bytes by 24 memory banks to provide the memory partition for a 3×3×32×32 convolution.

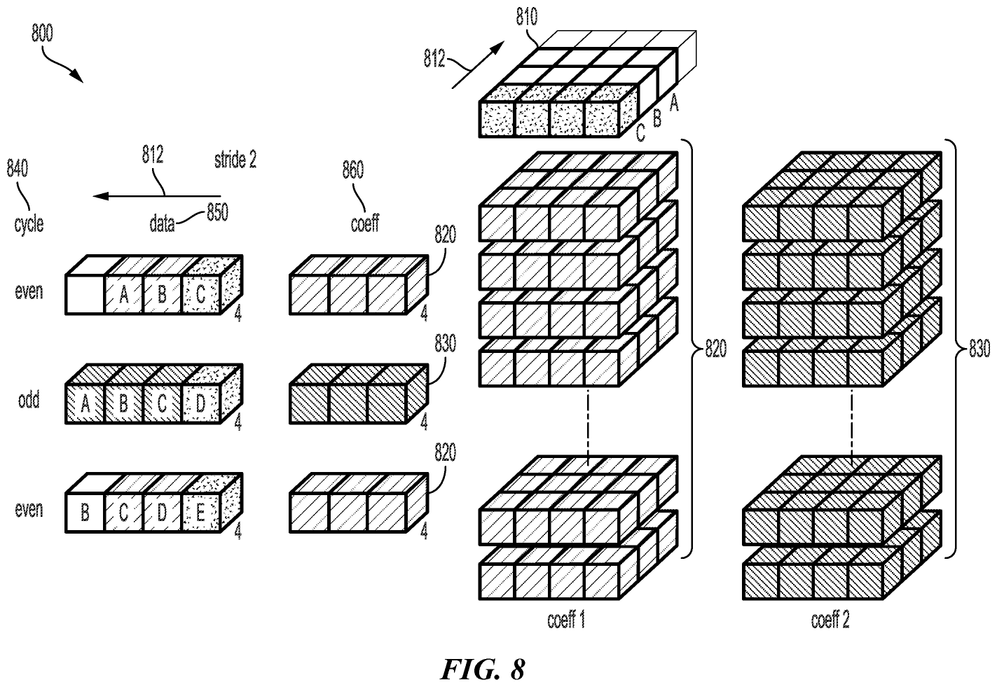

FIG. 8 is a block diagram illustrating interleaved data striding in a machine learning (ML) acceleration architecture, in accordance with aspects of the present disclosure. This example illustrates a memory partition 800 including a data slice 810 having data columns C, B, and A, according to a sliding window 812. In this example, two memory pages are provided to separate a set of coefficient into a first set of coefficient slices 820 (e.g., coeff 1) and a second set of coefficient slices 830 (e.g., coeff 2). For example, the set of coefficients may be used for 64 channel outputs that are split into the first set of coefficient slices 820 of 32 outputs and the second set of coefficient slices 830 of 32 outputs because prefetching is not available in this example.

Some aspects of the present disclosure provides interleaved striding including a sliding window 812, which may be referred as a streaming sliding window. This example illustrates a stride of two, in which data blocks are advanced by two pixels in both axes. As a result of the streaming sliding window, an output is valid every other cycle. To overcome this validity issue, interleaving MAC operations on the first set of coefficient slices 820 and the second set of coefficient slices 830 is performed to increase utilization, according to aspects of the present disclosure. For example, the first set of coefficient slices 820 is applied on even cycles, and the second set of coefficient slices 830 is applied in odd cycles, such that the memory pages of coefficients are toggled in each cycle.

In some aspects of the present disclosure, interleaved striding including the sliding window 812 is illustrated according to a cycle 840, data 850, and coefficient slices 860. During a first even cycle, the data 850 (e.g., C, B, A, _) is multiplied and accumulated with a coefficient slice from the first set of coefficient slices 830, where the underscore symbol represents unloaded data. During a first odd cycle, the data 850 is shifted (e.g., D, C, B, A) and multiplied and accumulated with a coefficient slice from the second set of coefficient slices 830. During a second even cycle, the data 850 (e.g., E, D, C, B) is multiplied and accumulated with a coefficient slice from the first set of coefficient slices 820. As a result, a new result is generated each cycle.

In addition, because the sliding window 812 advances on each cycle, in order to operate on a same data block, odd convolutions operate on a delayed version. In this example, the data window of the data 850 is extended by one column to accommodate the odd convolutions. In aspects of the present disclosure, the same data (e.g., C, B, A) is applied to the first set of coefficient slices 820 in the first even cycle and the odd cycle, as D is not part of the operation during the odd cycle. The input data D (e.g., an input pixel byte) does not becomes an element of the operation until the send event cycle (e.g., E, D, C, B). In this example, the stride of two is illustrated by comparing the data 850 (e.g., C, B, A, _) of the first even cycle and the data 850 (e.g., E, D, C, B) of the second even cycle to illustrate the stride of two between E and C of the data 850.

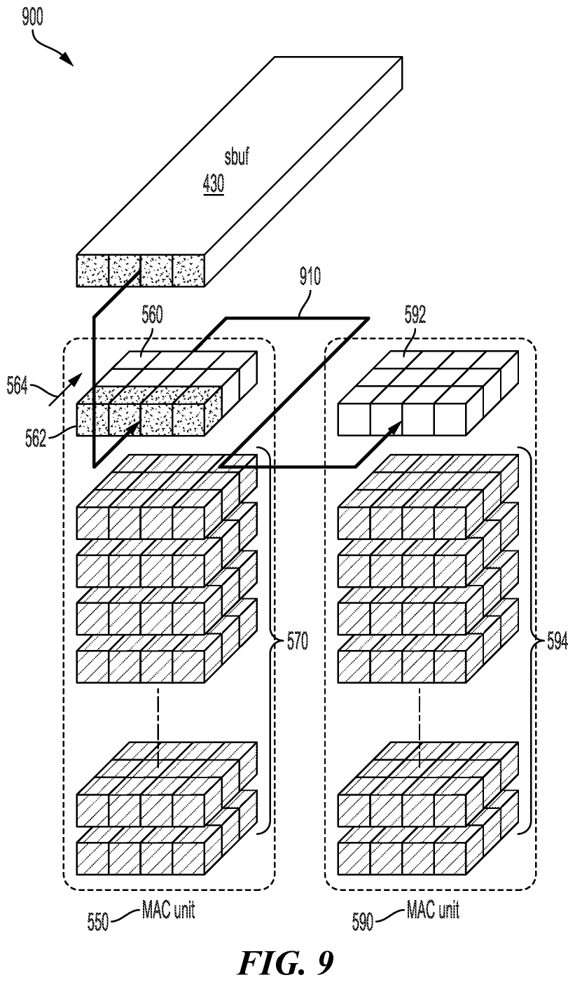

FIG. 9 is a block diagram illustrating a chaining of sliding data windows between multiply-accumulate (MAC) units of a MAC array, in accordance with aspects of the present disclosure. In this example, the MAC unit 550 includes a data slice 560 (e.g., with dimensions of 1×3×4) configured to stream a set of four channels according to a data sliding window that partitions memory into execution units. In this example, a first data column 562 of the data slice 560 is repeated for calculation with the current coefficient slices 570 during a cycle to perform a convolution operation. According to a sliding window 564 beginning with a first data column 562 of the data slice 560, a new data column of four input channels is used for each cycle to perform the convolution operation. This data reuse technique may be referred to as streaming of data of the data slice 560.

Some aspects of the present disclosure support chaining together sliding data windows of neighboring MAC units along a horizontal axis. In this example, the data slice 560 of the MAC unit 550 is coupled to a data slice 592 of a MAC unit 590 through a chain 910 coupled to the first storage buffer 430. The MAC unit 590 is also shown with coefficient slices 594 having similar dimension to the data slice 592. In this configuration, the MAC unit 550 and the MAC unit 550 may operate according to two modes of operation. In one mode of operation, the MAC unit 550 and/or the MAC unit 590 are fed by first storage buffer 430. In another mode of operation, the MAC unit 550 and/or the MAC unit 590 are fed by a tail of neighbor unit. In this example, if kernel size not a multiple of three, then zeros are assigned to unused coefficients of the current coefficient slices 570 and/or the coefficient slices 594.

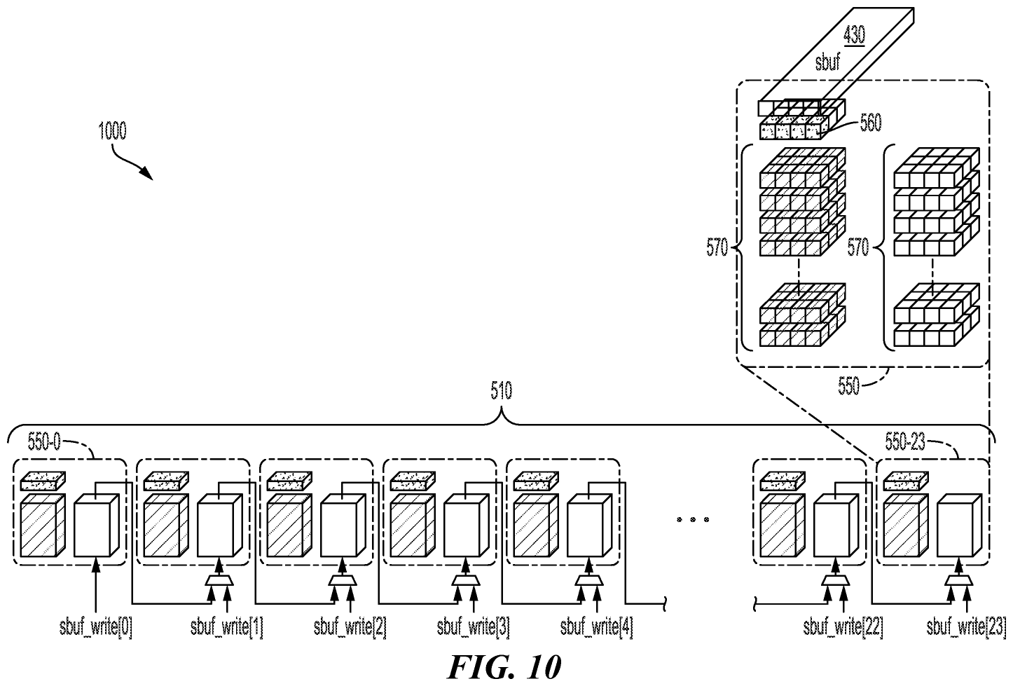

FIG. 10 further illustrates the MAC units 550 of the MAC array 510 according to a chaining configuration 1000 for parallel coefficient loading, in accordance with aspects of the present disclosure. In this example, 24 write interfaces of the first storage buffer 430 feed 24 MAC units (e.g., 550-0, . . . , 550-23). While a standard configuration of each MAC unit 550 of the MAC array 510 involves 96 cycles to perform a full reload of the coefficients, this chaining configuration 1000 of the MAC units 550 offers configurable parallelism. In this example, each MAC unit 550 has an optional flag, for chaining with its neighbor. For example, two of the MAC units 550 are specified for a parallel coefficient load, two chains of the MAC array 510 are split in the middle, with a first chain going from the MAC unit 550-0 to the MAC unit 550-11 and a second chain from the MAC unit 550-12 to the MAC unit 550-23. These aspects of the present disclosure include a process of chaining data sliding windows of neighboring MAC units of the MAC array 510.

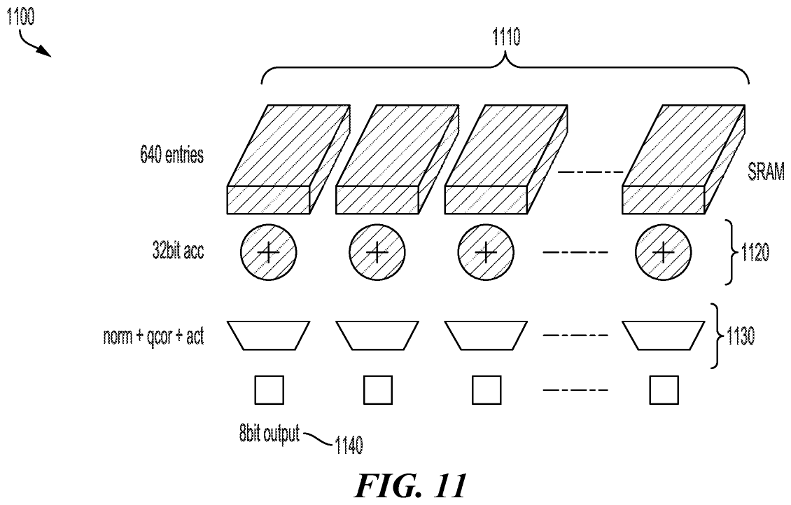

FIG. 11 is a block diagram further illustrating dedicated local accumulators to enable support for partial sums into intermediate buffers, according to aspects of the present disclosure. In one configuration, dedicated local accumulators 1100 include intermediate buffers 1110 to provide support for deeper network layers with more than 32 input channels. In this configuration, the intermediate buffers 1110 may be implemented as multi-pass partial read-modify-write SRAM buffers followed by an accumulator stage 1120. In this example, a line width storage of the intermediate buffers 1110 is shown as 640 entries. This line width storage of the intermediate buffers 1110 avoids the use of tilling.

In some aspects of the present disclosure, the dedicated local accumulators 1100 provide support for layers with more than 32 input channels found in deeper networks with striding, in which a line-width is more narrow than an input. This configuration of the dedicated local accumulators 1100 provides an efficient use of bandwidth and consumes less power. In operation, wide partials sums (e.g., 32 bits for 1K channels) compete with data transfers, which might involve the use of deeper SRAMs to implement the intermediate buffers 1110, which would consume more power. In this example, the intermediate buffers 1110 are implemented using 32 of the intermediate buffers 1110, which consumes a smaller footprint. An output stage 1130 performs output operations including normalization, q-correction, activation function, and other like output operations to generate an eight-bit output 1140.

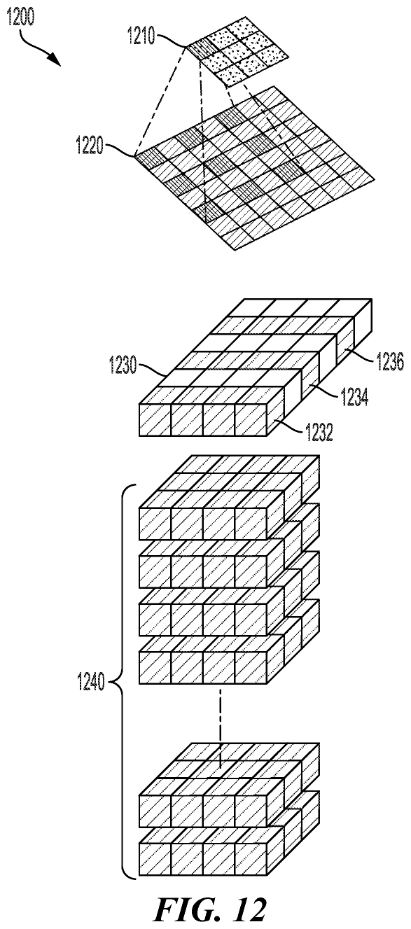

FIG. 12 is a block diagram illustrating a memory/data partition technique to perform various convolutions, in accordance with aspects of the present disclosure. Representatively, FIG. 12 illustrates a memory/data partition 1200 to perform a dilated convolution, in accordance with aspects of the present disclosure. The dilated convolution provides an alternative to striding for down-sampling, for example, as shown in FIG. 8. This example involves a minor architectural change to support dilated convolutions. In this example, a dilate=(2,2) operation is illustrated in which a sliding window 1210 is applied to coefficients 1220 according to a 2×2 pattern. This example also illustrates a data slice 1230 and corresponding coefficient slices 1240

In some aspects of the present disclosure, a sliding widow of the data slice 1230 is performed horizontally, such that the data-sliding window of the data slice 1230 may be extended in a horizontal direction. For example, in a dilate mode, for a 1×3 convolution, each second column (e.g., 1232, 1234, and 1236) of the data slice 1230 is available. In a vertical direction, line histories of the data slice 1230 are managed by the RICA array 420 of FIG. 4. As a result, dilated convolutions may be performed with special hardware support. In addition, the dilated convolutions realizes a full capacity of the MAC units, which does not involve a performance impact.

The memory/data partition may be modified to include padding and perform transposed convolutions, according to aspects of the present disclosure. In some aspects of the present disclosure, the RICA array 420 manages memory writes to implement padding as well as transposed convolutions. For example, the coefficient slices 1240 may be modified by performing zero padding along a perimeter of the coefficient slices 1240. Alternatively, the coefficient slices 1240 may be modified by performing mirror padding along a perimeter of the coefficient slices 1240. In addition, the coefficient slices 1240 may be modified by inserting padding around elements of the coefficient slices 1240 to enable a transposed convolution. This padding may be performed without hardware support in the MAC units. In addition, transposed convolutions may be performed in a similar manner to upscale interpolation followed by a regular convolution. For example, the interpolation is performed by the RICA array 420 without any change to the MAC units of the MAC array 510. In addition, the padding and transposed convolutions may operate in conjunction with striding or dilation described above.

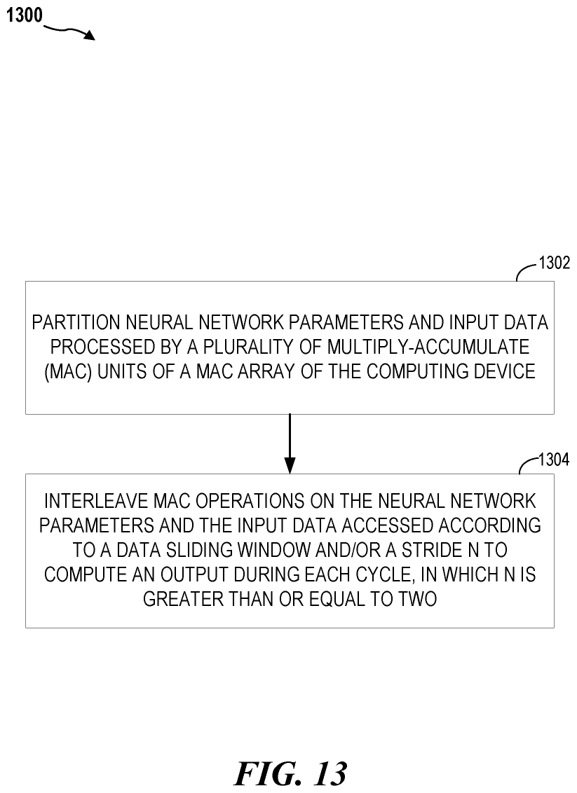

FIG. 13 is a flow diagram illustrating a method 1300 for accelerating machine learning on a computing device, in accordance with aspects of the present disclosure. The method 1300 begins at block 1302, in which neural network parameters and input data processed by a plurality of multiply-accumulate (MAC) units of a MAC array of the computing device are partitioned. For example, a MAC unit 550 is shown in an exploded view in FIG. 5B, including a data slice 560 (e.g., with dimensions of 1 row×3 columns×4 input channels (i.e., 1×3×4) according to a data slice format) configured to stream a set of four channels according to a data sliding window that partitions memory into execution units. As further illustrated in FIG. 5B, the MAC unit 550 includes 32 current coefficient slices 570 (e.g., with 1×3×4 dimensions according to a coefficient slice format) in a similar configuration to the data slice 560.

At block 1304, MAC operations on the neural network parameters are interleaved with the input data accessed according to a data sliding window and/or a stride N to compute an output during each cycle, in which N is greater than or equal to two. For example, FIG. 8 illustrates interleaved data striding in a machine learning (ML) acceleration architecture. This example illustrates the memory partition 800 including a data slice 810 having data columns C, B, and A, according to a sliding window 812. In this example, two memory pages are provided to separate a set of coefficient into a first set of coefficient slices 820 (e.g., coeff 1) and a second set of coefficient slices 830 (e.g., coeff 2). For example, the set of coefficients may be used for 64 channel outputs that are split into the first set of coefficient slices 820 of 32 outputs and the second set of coefficient slices 830 of 32 outputs because prefetching is not available in this example to perform convolution operation between the data and coefficients.

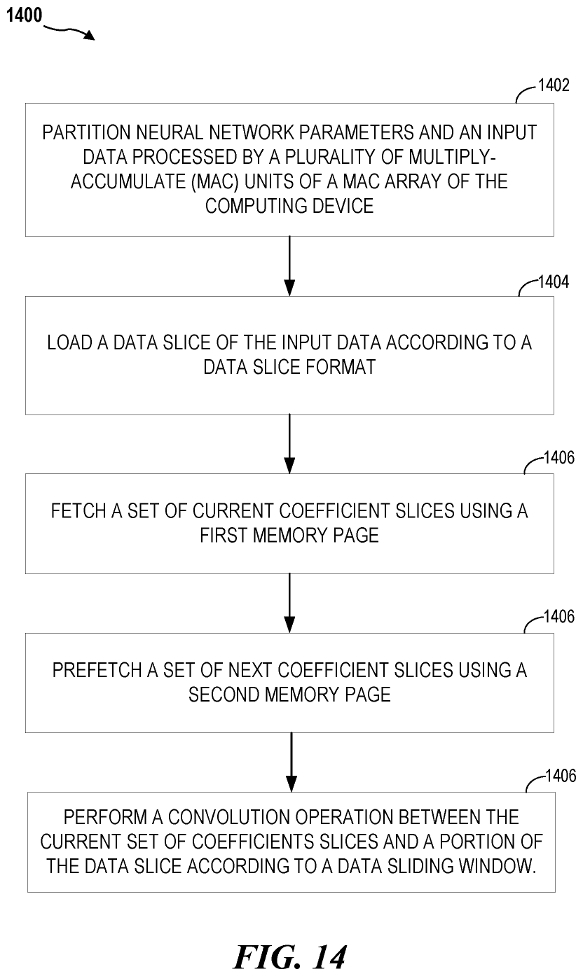

FIG. 14 is a flow diagram illustrating a method 1400 for accelerating machine learning on a computing device, according to aspects of the present disclosure. The method 1400 begins at block 1402, in which neural network parameters and an input data processed by a plurality of multiply-accumulate (MAC) units of a MAC array of the computing device are partitioned. For example, FIG. 8 illustrates the memory partition 800 including the data slice 810 having data columns C, B, and A, according to a sliding window 812. FIG. 5B, including the data slice 560 configured to stream a set of four channels according to a data sliding window that partitions memory into execution units. In addition, the MAC unit 550 includes 32 current coefficient slices 570 (e.g., with 1×3×4 dimensions according to a coefficient slice format) in a similar configuration to the data slice 560.

At block 1404, a data slice of the input data is loaded according to a data slice format. For example, the MAC unit 550 is shown in the exploded view in FIG. 5B, including the data slice 560 (e.g., with dimensions of 1 row×3 columns×4 input channels (i.e., 1×3×4) according to the data slice format) configured to stream a set of four channels according to a data sliding window that partitions memory into execution units.

At block 1406, a set of current coefficient slices is fetched using a first memory page. At block 1408, a set of next coefficient slices is prefetched using a second memory page. For example, as shown in FIG. 5B, two memory pages (e.g., a first memory page and a second memory page) provided by the MAC unit 550 allow fetching a set of current coefficient slices 570 and prefetching a set of next coefficient slices 580. The prefetching of the set of next coefficient slices 580 hides away loading during execution of a current line of coefficients.

At block 1410, a convolution operation is performed between the current set of coefficients slices and a portion of the data slice according to a data sliding window. For example, as shown in FIG. 8, depicts interleaved striding including the sliding window 812, which is illustrated according to the cycle 840, the data 850, and the coefficient slices 860. During the first even cycle, the data 850 (e.g., C, B, A, _) is multiplied and accumulated with the coefficient slice from the first set of coefficient slices 830. During the first odd cycle, the data 850 is shifted (e.g., D, C, B, A) and multiplied and accumulated with the coefficient slice from the second set of coefficient slices 830. During the second even cycle, the data 850 (e.g., E, D, C, B) is multiplied and accumulated with a coefficient slice from the first set of coefficient slices 820. As a result, a new convolution result is generated each cycle.

The method 1400 also includes loading the input data according to a data slice format, and loading coefficients according to a coefficient slice format. In some aspects of the present disclosure the method 1400 loads the input data by loading one row of three columns of four input channels of the input data. Alternatively, the method 1400 loads the input data by loading one column of four input channels of the input data. The method 1400 also loads the coefficients by loading one row of three columns of four coefficient channels of the coefficients. Alternatively, the method 1400 loads the coefficients by loading one column of four coefficient channels of the coefficients.

In some aspects, the methods 1300, 1400 may be performed by the SoC 100 (FIG. 1). That is, each of the elements of the methods 1300, 1400 may, for example, but without limitation, be performed by the SoC 100 or one or more processors (e.g., CPU 102 and/or NPU 108) and/or other components included therein.

Implementation examples are described in the following numbered clauses:

1. A method for accelerating machine learning on a computing device, comprising:
partitioning neural network parameters and input data processed by a plurality of multiply-accumulate (MAC) units of a MAC array of the computing device; and
interleaving MAC operations on the neural network parameters and the input data accessed according to a data sliding window and/or a stride N to compute an output during each cycle, in which N is greater than or equal to two.

2. The method of clause 1, further comprises:
loading the input data according to a data slice format; and
loading coefficients according to a coefficient slice format.

3. The method of clause 2, in which loading the input data comprises loading one row of three columns of four input channels of the input data.

4. The method of clause 2, in which loading the input data comprises loading one column of four input channels of the input data.

5. The method of any of clauses 2-4, in which loading the coefficients comprises loading one row of three columns of four coefficient channels of the coefficients.

6. The method of any of clauses 2-4, in which loading the coefficients comprises loading one column of four coefficient channels of the coefficients.

7. The method of any of clauses 1-6, in which the MAC operations comprise a depth-wise convolution.

8. The method of any of clauses 1-7, further comprising chaining data sliding windows of neighboring MAC units of the MAC array.

9. The method of any of clauses 1-8, in which N equals two.

10. The method of any of clauses 1-9, in which the input data comprises sensor image data.

11. A method for accelerating machine learning on a computing device, comprising:
partitioning neural network parameters and an input data processed by a plurality of multiply-accumulate (MAC) units of a MAC array of the computing device;
loading a data slice of the input data according to a data slice format;
fetching a set of current coefficient slices using a first memory page;
prefetching a set of next coefficient slices using a second memory page; and
performing a convolution operation between the current set of coefficients slices and a portion of the data slice according to a data sliding window.

12. The method of clause 11, in which the convolution operation comprises a depth-wise convolution.

13. The method of any of clauses 11-12, further comprising chaining data sliding windows of neighboring MAC units of the MAC array.

14. The method of any of clauses 11-13, in which the data slice format comprises one (1) row by three (3) columns of four (4) input channels (1×3×4).

15. A system for a machine learning (ML) acceleration architecture, the system comprising:
a machine learning (ML) accelerator; and
a reconfigurable system on chip (SoC) coupled top the ML accelerator, the reconfigurable SoC configured to partition neural network parameters and input data processed by ML accelerator, and the ML accelerator configured to interleave operations on the neural network parameters and the input data accessed according to a data sliding window and/or a stride N to compute an output during each cycle, in which N is greater than or equal to two.

16. The system of clause 15, in which the reconfigurable SoC comprises a reconfigurable instruction cell array (RICA) coupled to a program random access memory (PRAM), a magnetic random access memory (MRAM), a first memory buffer and a second memory buffer.

17. The system of any of clauses 15-16, in which the ML accelerator comprises multiply-accumulate (MAC) array, comprising a plurality of MAC units.

18. The system of clause 17, in which data sliding windows of neighboring MAC units of the MAC array are coupled in series.

19. The system of any of clauses 17-18, in which at least one of the plurality of MAC units is configured to perform a convolution operation between a current set of coefficients slices and a portion of a data slice according to the data sliding window.

20. The system of any of clauses 15-19, further comprising a sensor coupled to the reconfigurable SoC to form a camera.

The system for accelerating machine learning includes means for partitioning neural network parameters and input data processed by a plurality of multiply-accumulate (MAC) units of a MAC array of the computing device. In some aspects, the partitioning means may be the RICA 420 configured to perform the functions recited. The system for accelerating machine learning includes means for interleaving MAC operations on the neural network parameters and the input data accessed according to a data sliding window and/or a stride N to compute an output during each cycle, in which N is greater than or equal to one. In some aspects, the interleaving means may be the MAC array 410 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed, include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage, or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein, may be downloaded and/or otherwise obtained by a user terminal and/or base station as applicable. For example, such a device can be coupled to a server to facilitate the transfer of means for performing the methods described herein. Alternatively, various methods described herein, may be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for accelerating machine learning on a computing device, comprising:
partitioning neural network parameters and input data processed by a plurality of multiply-accumulate (MAC) units of a MAC array of the computing device; and
interleaving MAC operations on the neural network parameters and the input data accessed according to a data sliding window and/or a stride N to compute an output during each cycle, in which N is greater than or equal to one.

2. The method of claim 1, further comprises:
loading the input data according to a data slice format; and
loading coefficients according to a coefficient slice format.

3. The method of claim 2, in which loading the input data comprises loading one row of three columns of four input channels of the input data.

4. The method of claim 2, in which loading the input data comprises loading one column of four input channels of the input data.

5. The method of claim 2, in which loading the coefficients comprises loading one row of three columns of four coefficient channels of the coefficients.

6. The method of claim 2, in which loading the coefficients comprises loading one column of four coefficient channels of the coefficients.

7. The method of claim 1, in which the MAC operations comprise a depth-wise convolution.

8. The method of claim 1, further comprising chaining data sliding windows of neighboring MAC units of the MAC array.

9. The method of claim 1, in which N equals two.

10. The method of claim 1, in which the input data comprises sensor image data.

11. A method for accelerating machine learning on a computing device, comprising:
partitioning neural network parameters and an input data processed by a plurality of multiply-accumulate (MAC) units of a MAC array of the computing device;
loading a data slice of the input data according to a data slice format;
fetching a set of current coefficient slices using a first memory page;
prefetching a set of next coefficient slices using a second memory page; and
performing a convolution operation between the set of current coefficients slices and a portion of the data slice according to a data sliding window.

12. The method of claim 11, in which the convolution operation comprises a depth-wise convolution.

13. The method of claim 11, further comprising chaining data sliding windows of neighboring MAC units of the MAC array.

14. The method of claim 11, in which the data slice format comprises one (1) row by three (3) columns of four (4) input channels (1×3×4).

15. A system for a machine learning (ML) acceleration architecture, the system comprising:
a machine learning (ML) accelerator; and
a reconfigurable system on chip (SoC) coupled top the ML accelerator, the reconfigurable SoC configured to partition neural network parameters and input data processed by ML accelerator, and the ML accelerator configured to interleave operations on the neural network parameters and the input data accessed according to a data sliding window and/or a stride N to compute an output during each cycle, in which N is greater than or equal to one.

16. The system of claim 15, in which the reconfigurable SoC comprises a reconfigurable instruction cell array (RICA) coupled to a program random access memory (PRAM), a magnetic random access memory (MRAM), a first memory buffer and a second memory buffer.

17. The system of claim 15, in which the ML accelerator comprises a multiply-accumulate (MAC) array, comprising a plurality of MAC units.

18. The system of claim 17, in which data sliding windows of neighboring MAC units of the MAC array are coupled in series.

19. The system of claim 17, in which at least one of the plurality of MAC units is configured to perform a convolution operation between a current set of coefficients slices and a portion of a data slice according to the data sliding window.

20. The system of claim 15, further comprising a sensor coupled to the reconfigurable SoC to form a camera.
